(19) United States
(12) Patent Application Publication
(10) Pub. No.: US 2025/0164669 A1
(43) Pub. Date: May 22, 2025

(54) LASER DIODE BEAM CORRECTION, COMBINING, AND COUPLING USING METALENS DOUBLETS

(71) Applicant: UNIVERSITY OF MASSACHUSETTS, Westborough, MA (US)

(72) Inventors: Amir Arbabi, Westfield, MA (US); Andrew Corby McClung, Florence, MA (US)

(21) Appl. No.: 18/953,545

(22) Filed: Nov. 20, 2024

Related U.S. Application Data
(60) Provisional application No. 63/600,849, filed on Nov. 20, 2023.

(51) Int. Cl. G02B 3/08; G02B 1/00; G02B 6/12; G02B 6/122; G02B 27/09; G02B 27/30

(52) U.S. Cl. CPC G02B 3/08; G02B 1/002; G02B 6/122; G02B 27/0916; G02B 27/0927; G02B 27/0955; G02B 27/30; G02B 2006/12038; G02B 2006/12061; G02B 2006/12102; G02B 2006/12107; G02B 2006/12147

(57) ABSTRACT

The present disclosure provides systems and methods for coupling light in imaging systems. One such system comprises a metalens doublet structure having a first substrate; a first metalens structure provided at a surface of the first substrate and comprising a plurality of first scatterers; and a second metalens structure provided at a second substrate or on another surface of the first substrate and comprising a plurality of second scatterers. Accordingly, the plurality of first scatterers is configured to reshape the intensity distribution of light that is received by the first metalens structure at a location of the second metalens structure; and the plurality of second scatterers is configured to change a wavefront of the light outputted from the first metalens structure and incident on the second metalens structure.

### CROSS-REFERENCE TO RELATED APPLICATION

This application claims priority to co-pending U.S. provisional application entitled, “Laser Diode Beam Correction, Combining, and Coupling Using Metalens Doublets,” having application No. 63/600,849, filed Nov. 20, 2023, which is entirely incorporated herein by reference.

### STATEMENT REGARDING FEDERALLY SPONSORED RESEARCH OR DEVELOPMENT

This invention was made with government support under contract HR00111720035 awarded by the Defense Advanced Research Projects Agency. The government has certain rights in the invention.

### BACKGROUND

Laser diodes are low-cost, compact lasers with low power consumption. These features have made them ubiquitous and an integral component of many consumer and industrial products. Although laser diodes are low-cost, the components needed to improve the quality of their beams and their alignment and assembly procedure are expensive. For example, the output beams of laser diodes, especially the edge emitters, are typically quickly diverging, astigmatic elliptical beams, which makes their collimation and fiber coupling difficult. Optical lenses can be used to collect and direct incoming light by refraction using a curve in the optical lens to bend the light rays. However, to make a small laser or imaging device, a short focal length is often required of the lens which causes the lens to require greater curvature and thickness. Since highly curved lenses typically suffer from aberrations, small laser or imaging devices often require multiple optical lenses which adds to their cost, size, and complexity.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a block diagram of an exemplary laser diode system in accordance with various embodiments of the present disclosure.

FIG. 1B shows a measurement setup for measuring a beam profile in accordance with the present disclosure.

FIGS. 2A to 2C show individually shaped scatterers in accordance with various embodiments of the present disclosure.

FIG. 3 is an exemplary diagram of an arrangement of scatters for a metalens structure in accordance with various embodiments of the present disclosure.

FIG. 4 is a block diagram of an exemplary laser diode system in accordance with various embodiments of the present disclosure.

FIGS. 5 and 6 show fabrication components of an exemplary metalens doublet apparatus in accordance with various embodiments of the present disclosure.

FIG. 7 shows an scanning electron microscope of an exemplary metalens doublet apparatus prototype formed of two bonded substrate pieces in accordance with various embodiments of the present disclosure.

FIG. 8A is a schematic drawing of an exemplary coupler array and imaging system showing the coupling between photonic integrated circuits in accordance with various embodiments of the present disclosure.

FIG. 8B is a schematic drawing of an inversed-designed coupler using a 2-level silicon etch and a bilayer coupler employing both silicon and Si₃N₄ layers in accordance with various embodiments of the present disclosure.

FIG. 8C is a schematic drawing of an array of grating couplers in accordance with FIGS. 8A-8B.

FIG. 9 is a schematic drawing of an exemplary coupler array and imaging system showing the coupling between a photonic integrated circuit and a fiber array in accordance with various embodiments.

FIG. 10A is a schematic drawing of a shape-optimized grating coupler in accordance with various embodiments of the present disclosure.

FIG. 10B shows simulations results of an optimized design of the shape-optimized grating coupler of FIG. 10A.

FIG. 10C is a schematic drawing of an alternative array of grating couplers in accordance with FIGS. 8A-8B.

FIGS. 11A and 11B show ray tracing simulation results for a diffraction-limited metalens doublet apparatus with a magnification of one and a magnification of two, respectively, in accordance with various embodiments of the present disclosure.

FIG. 12A is a schematic drawing of varying views of a metalens structure formed with nano-posts in accordance with various embodiments of the present disclosure.

FIG. 12B shows scanning electron microscope (SEM) images of aSi and TiO₂ nano-posts in accordance with FIG. 12A.

FIGS. 13A-13C show an exemplary plan for the alignment and bonding steps needed for implementing the disclosed coupling approach, in accordance with various embodiments.

### DETAILED DESCRIPTION

The present disclosure presents a new design for laser diode systems utilizing a metalens doublet apparatus to correct ellipticity and astigmatism of laser diode output beams and/or to collimate, focus, or combine the laser diode output beams. Metalenses have strong advantages over conventional optical lenses, including their thin profile and low weight. As such, the flatness of metalenses enable fabrication of compact systems.

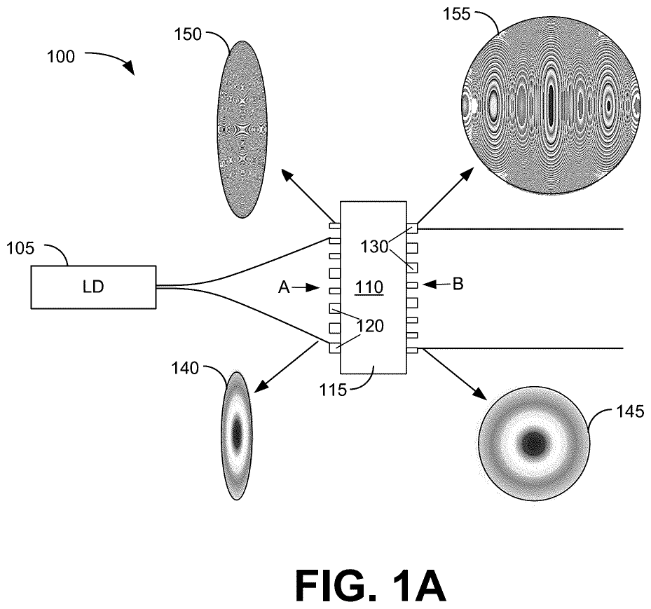

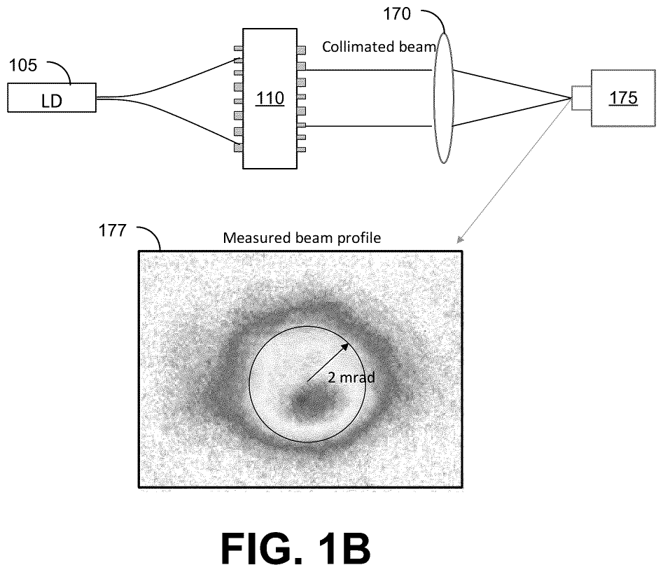

Referring now to FIG. 1A, an exemplary laser diode system 100 of the present disclosure is presented. In the figure, a metalens doublet apparatus 110 is provided to shape an output beam of a laser diode (LD) 105. The metalens doublet apparatus 110 comprises two cascaded metalenses A, B, in which each metalens structure is a 2D array of nanostructures that is designed to shape and/or change the path of optical wavefronts of the laser diode output beam. By using two cascaded metalenses A, B, an output beam of the laser diode 105 can be circularized or reshaped via the front or first metalens A and then collimated or focused via the rear or second metalens B. In various embodiments, for example, the laser diode output beam can be directed or focused onto an end of a waveguide structure by the metalens doublet apparatus 110. Alternatively, or in addition, to, an array of metalens doublet apparatuses may also be used to combine output beams of multiple laser diodes, in various embodiments. Accordingly, an exemplary laser diode system 100 of the present disclosure enables low-cost and miniature beam shapers/couplers for laser diode systems that can generate high-quality beams and/or couple them with high efficiency to optical fibers or other waveguides.

Referring to FIG. 1A, the metalens doublet apparatus 110 may include a substrate 115 and a first metalens structure A having a plurality of scatterers 120 (e.g., nanopillars) provided at one side of the substrate 115. Correspondingly, the metalens doublet apparatus 110 may include a second metalens structure B having a plurality of scatterers 130 provided at an opposite side of the substrate 115.

In the first metalens structure A, the plurality of scatterers 120 are arranged to change a shape of an incident light beam from a laser diode 105. Accordingly, the first metalens structure can have a phase profile that is designed to reshape an intensity distribution of the laser diode's beam as the light passes through the plurality of scatterers 120 such that the reshaped intensity distribution will match a desired intensity distribution at a location of the second metalens structure B. For example, the phase profile may be designed to expand a narrow dimension (e.g., along a horizontal axis) of the beam so that it will be similar in size to a wider dimension of the beam (e.g., along a vertical axis).

Accordingly, in the second metalens structure B, the plurality of scatterers 130 are arranged to change a wavefront of an incident light beam from the first metalens structure A. As a non-limiting example, the second metalens structure B can have a phase profile that is designed to flatten the wavefront of the incident light beam and add any additional wavefront that is desirable, such as converging the wavefront for focusing or deflecting the wavefront to another angle (e.g., in order to collimate an output light beam from the second metalens B).

To demonstrate, in FIG. 1A, an example design of the metalens doublet apparatus 110 is depicted as having a first metalens structure A on a front side of the substrate 115 and a second metalens structure B on a rear side of the substrate 115 (e.g., having a 1.055 mm width in this non-limiting example). Additionally, a laser beam output of a laser diode LD (e.g., that is positioned 400 μm from the first metalens structure A) has an elliptical-shaped intensity distribution 140 at the first metalens structure. In this example, the first metalens structure A has a phase profile 150 that is designed to reshape the intensity distribution of the laser diode 105 (e.g., from an elliptical-shaped intensity distribution) to a circular-shaped intensity distribution. Accordingly, the second metalens structure B has a phase profile 155 that is designed to change a path or wavefront of the laser beam as the light passes through the plurality of scatterers 130 so that the beam is collimated in addition to having a circular-shaped intensity distribution. Therefore, a laser beam output of the metalens doublet apparatus 110 is shown to have a circular-shaped intensity distribution 145 after the light is passed through the second metalens structure B.

In order to obtain laser beam outputs, a measurement setup was performed for the exemplary laser diode system 100 that involved adding an optical filter 170 to focus a laser beam output onto a lens of a camera 175 so that a beam profile image 177 may be obtained/measured, as illustrated in FIG. 1B.

In general, elliptical beam shapes can be undesirable, since the focused spot size is larger than if the beam were circular, where larger spot sizes have lower irradiances (power per area). Consequently, if a certain irradiance is needed, and the laser beam is not circularized, it will be necessary to increase the laser power. Therefore, transforming an elliptical light beam to a circular light beam is often advantageous. However, in various embodiments, other types of changes can be performed, such as changing one type of elliptical beam shape to a different type of elliptical beam shape, as a non-limiting example.

Shapes and materials of the plurality of scatterers 120, 130 may vary according to functions performed by the plurality of scatterers 120, 130. For example, the plurality of scatterers 120, 130 of the metalens doublet apparatus 110 device of FIG. 1A may have a shape and a size appropriate for performing a function of a lens with positive refractive power, negative refractive power, etc.

In various embodiments, the plurality of first and the plurality of second scatterers 120, 130 may capture light incident near one another and resonate light inside the plurality of first and second scatterers 120, 130. Accordingly, waveform of light that passes through the metalenses A, B may vary according to shapes, arrangement intervals, and an arrangement pattern of the plurality of scatterers. As such, the plurality of first and/or second scatterers 120, 130 may adjust transmission and reflection properties of the light incident on the plurality of first and/or second scatterers 120, 130. For example, the plurality of first and/or second scatterers 120, 130 may modulate at least one of an amplitude, phase, or polarization of transmitted light according to structures and included materials of the plurality of first and/or second scatterers 120, 130. The plurality of first and/or second scatterers 120, 130 may be arranged such that distribution of at least one of an amplitude, phase, or polarization of the transmitted light is modulated and thus a wavefront of the transmitted light changes with respect to a wavefront of the incident light. Therefore, the plurality of first and/or second scatterers 120, 130 may change a proceeding direction of the transmitted light with respect to that of the incident light.

In various embodiments, the substrate 115 may be shaped as a plate. Correspondingly, the first and second metalenses A, B of the substrate 115 may be substantially parallel to each other. However, the first and second surfaces A, B do not have to be completely parallel to each other but may be oblique with respect to each other. In various embodiments, the substrate 115 may include a transparent material. The transparent material indicates a material with a high light transmission rate. For example, the substrate 115 may include at least one selected from glass (fused silica, BK7, etc.), quartz, polymer (PMMA, SU-8, etc.), and plastic.

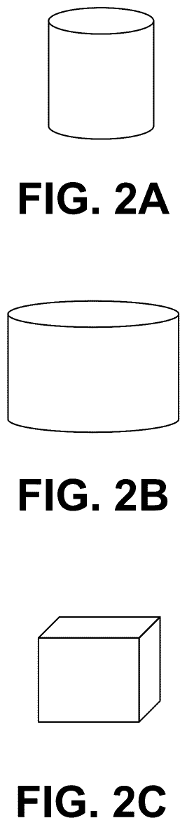

Referring now to FIGS. 2A to 2C, the individual scatterers of the plurality of first and the individual scatterers of the plurality of second scatterers 120, 130 in the first and second metalenses A, B may have a pillar structure. Such pillar structure may have any one of circular, oval, rectangular, and square cross-sections and/or may have varying heights with respect to one another. FIG. 2A shows a scatterer shaped as a pillar with a circular cross-section. FIG. 2B shows a scatterer shaped as a pillar with an oval cross-section. FIG. 2C shows a scatterer shaped as a pillar with a quadrilateral cross-section. The pillar structure may be inclined at an angle in a height direction, have asymmetric shapes, or other sophisticated design elements, in various embodiments.

Although exemplary shapes of the plurality of first and the plurality of second scatterers 120, 130 are shown in FIGS. 2A to 2C, exemplary embodiments are not limited thereto. For example, the plurality of first and plurality of second scatterers 120, 130 may be shaped as polyhedral pillars or pillars with an L-shaped cross-section. The shapes of the plurality of first and plurality of second scatterers 120, 130 may be asymmetrical in a direction. For example, respective cross-sections of the plurality of first and the plurality of second scatterers 120, 130 may be asymmetrical in a horizontal direction. Also, since the respective cross-sections of the plurality of first and the plurality of second scatterers 120, 130 may vary according to respective heights of the plurality of first and the plurality of second scatterers 120, 130, respective shapes of the plurality of first and the plurality of second scatterers 120, 130 may be asymmetrical with respect to the respective heights thereof.

Respective refractive indexes of the plurality of first and the plurality of second scatterers 120, 130 may be higher than a refractive index of the substrate 115. For example, the respective refractive indexes of the plurality of first and the plurality of second scatterers 120, 130 may be greater than the refractive index of the substrate 115 by approximately 1 or more. Therefore, the substrate 115 may include a material with a relatively low refractive index, and the plurality of first and the plurality of second scatterers 120, 130 may include a material with a relatively high refractive index. For example, the plurality of first and the plurality of second scatterers 120, 130 may include at least one selected from crystalline silicon (c-Si), polycrystalline silicon (poly Si), amorphous silicon, Si₃N₄, GaP, GaAs, TiO₂, AlSb, AlAs, AlGaAs, AlGaInP, BP, and ZnGeP₂. The plurality of first and the plurality of second scatterers 120, 130 may be additionally surrounded by materials with a low refractive index (SiO₂, polymer (PMMA, SU-8, etc.)) in upper and horizontal directions.

Design conditions of the plurality of first scatterers 120 may be modified according to the phase profile of the first metalens A and design conditions of the plurality of second scatterers 130 may be modified according to the phase profile of the second metalens B. For example, at least one of the shapes, the sizes, the materials, and the arrangement pattern of a plurality of scatterers 120, 130 may be modified according to an arranged location of the plurality of scatterers 120, 130 on a surface of the substrate 115.

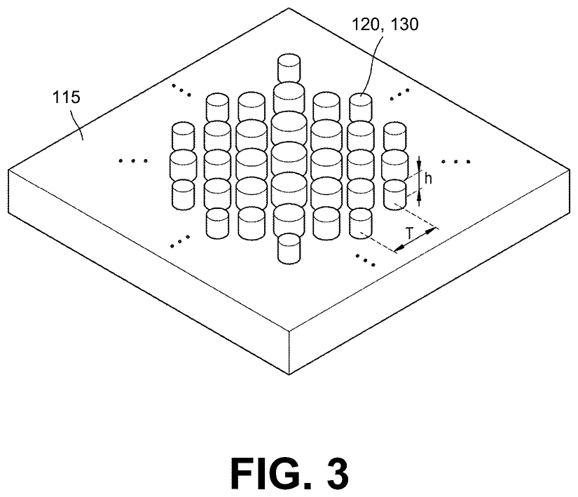

As represented in FIG. 3, intervals T between the plurality of scatterers 120, 130, respective heights h of the plurality of scatterers 120, 130, and an arrangement pattern of the plurality of scatterers 120, 130 may be determined according to a design wavelength of the particular metalens A, B. The intervals T between the plurality of scatterers 120, 130 may be less than the design wavelength. For example, the intervals between the plurality of scatterers 120, 130 may be equal to or less than ¾ or ⅔ of the design wavelength. Also, the respective heights h of the plurality of scatterers 120, 130 may be less than the design wavelength. For example, the respective heights h of the plurality of scatterers 120, 130 may be equal to or less than ⅔ of the design wavelength.

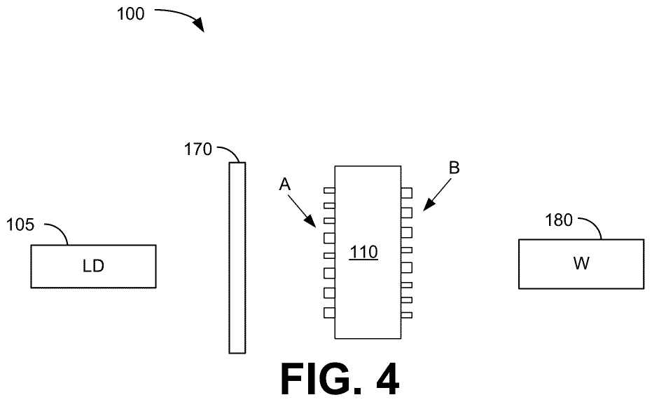

In various embodiments, as represented in FIG. 4, the metalens doublet apparatus 110 may include an optical filter 170 that blocks wavelengths of the incident light which are different from the design wavelength of the first metalens A. The optical filter 170 may transmit light having a wavelength equal or similar to the design wavelength of the first metalens from the incident light. Also, the optical filter 170 may reflect or absorb light having a wavelength that is not similar to the design wavelength. The optical filter 170 may filter the wavelength of incident light and thus prevent a light component with a weak focusing effect from reaching a focal plane of the metalens doublet apparatus 110.

In the figure, a metalens doublet apparatus 110 is provided to shape an output beam of a laser diode (LD) 105. The metalens doublet apparatus 110 comprises two cascaded metalenses A, B, in which each metalens structure is a 2D array of nanostructures that is designed to shape and/or change the path of optical wavefronts of the laser diode output beam. By using two cascaded metalenses A, B, an output beam of the laser diode 105 can be circularized or reshaped via the front or first metalens A and then collimated or focused via the rear or second metalens B. In various embodiments, the laser diode output beam can be directed or focused onto an end of a waveguide structure 180 by the metalens doublet apparatus 110. Alternatively, or in addition, to, an array of metalens doublet apparatuses may also use to combine output beams of multiple laser diodes, in various embodiments. Accordingly, an exemplary laser diode system 100 of the present disclosure enables low-cost and miniature beam shapers/couplers for laser diode systems that can generate high-quality beams and/or couple them with high efficiency to optical fibers or other waveguides.

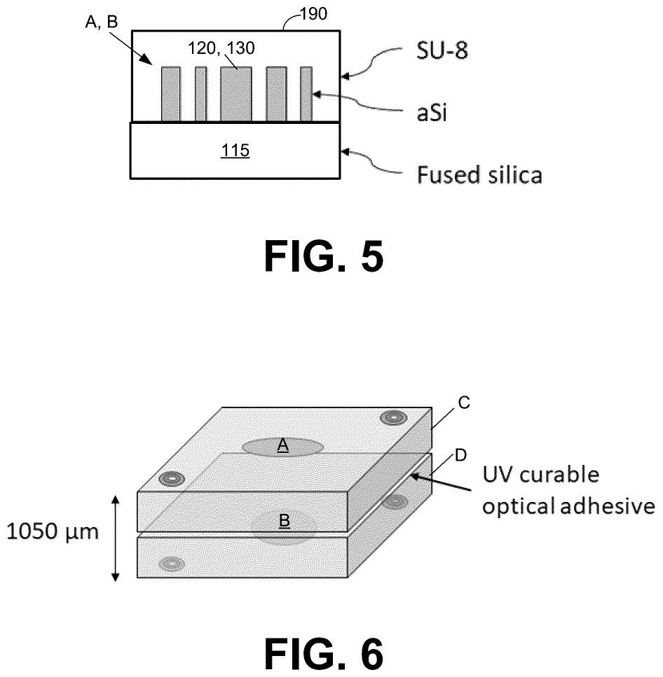

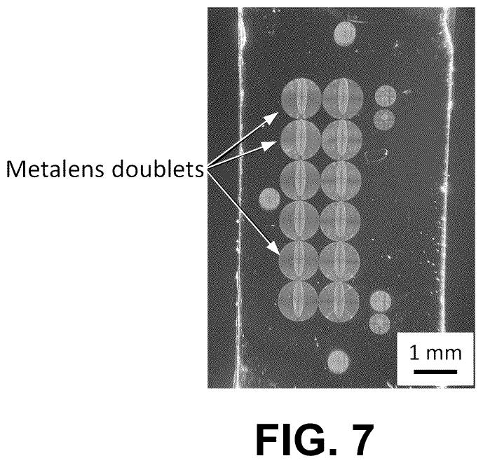

In an exemplary implementation, a metalens structure A, B of the metalens doublet apparatus is fabricated using scatterers 120, 130 formed of amorphous silicon on a glass substrate 115 (e.g., fused silica), as illustrated in FIG. 5. In various embodiments, the metalens structure A, B is also cladded or coated with a photoresist material 190 (e.g., SU-8 material). Accordingly, in various embodiments, individual metalens structures A, B are fabricated on two pieces or layers C, D of substrate 115 that are aligned and bonded (e.g., using a UV curable optical adhesive) to produce the metalens doublet apparatus 110, as illustrated in FIG. 6 and FIG. 7. In alternative embodiments, the metalens structures A, B are fabricated on a single solid piece of substrate 115. In an exemplary implementation, a height of the metalens doublet apparatus 110 is approximately 1050 μm. In an exemplary implementation, a height of one or more of the scatterer structurers is approximately 560 nm.

In order to design and configure a metalens structure with a desired phase profile, computer and software tools are available to calculate the way light waves interact with scatterer materials and dimensions such that these calculations can be converted into design files that can be used with standard semiconductor processing/manufacturing equipment. In various embodiments, for such metalens structures, a phase of incident light can be modulated by resonant effect, non-resonant effect, or by a combination of both.

Efficient optical coupling into and out of photonic integrated circuits (PICs) has been a challenging task, and edge and grating coupling have regularly been employed. Grating couplers enable wafer-level testing, assembly, and packaging, but they have a narrower bandwidth and higher loss than edge couplers. Thus, 3D integration of multiple PICs and electronic chips requires their stacking, and grating couplers can offer vertical optical communications between the chips provided their shortcomings are addressed.

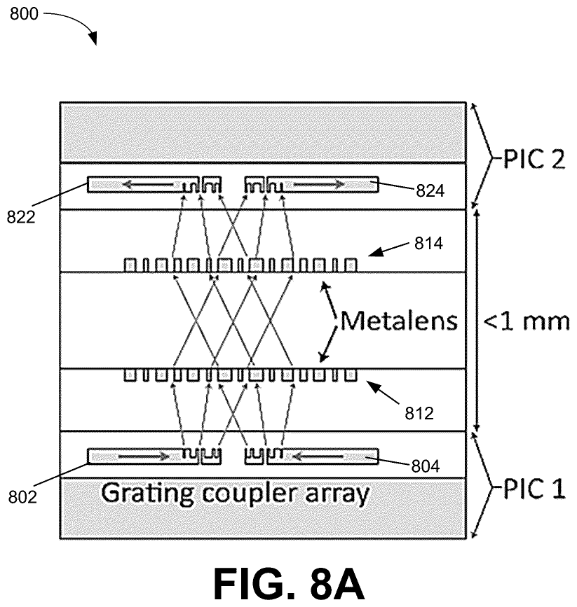

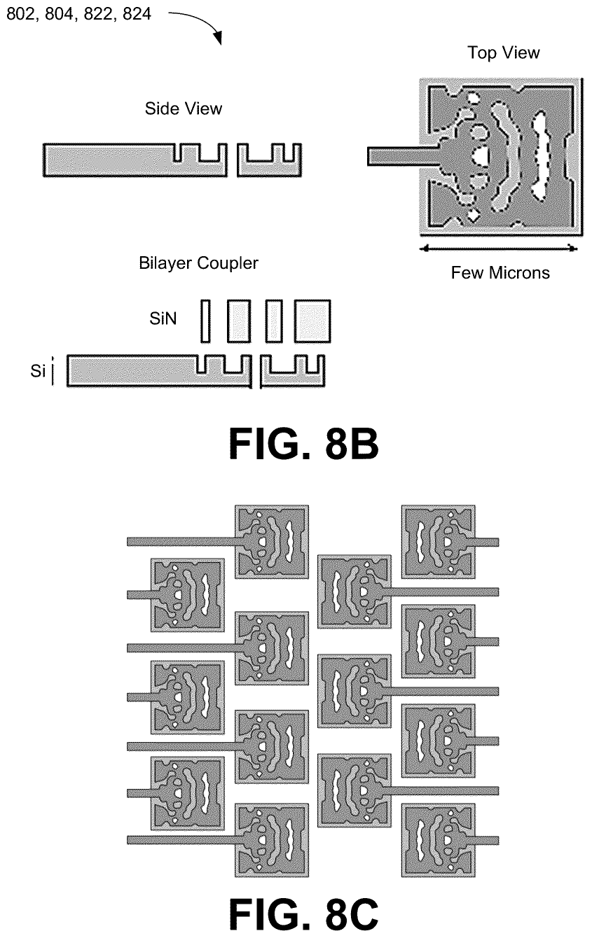

FIG. 8A shows a drawing of an exemplary coupler array and imaging system, which uses small-area wideband grating coupler arrays 802, 804, 822, 824 that emit normal to a photonic integrated circuit's surface. Within the photonic integrated circuit (PIC 1), diverging light emitted by the grating couplers 802, 804 is captured and imaged by metalens doublet apparatus having a first metalens structure 812 and a second metalens structure 814 and is coupled into grating couplers 822, 824 on another PIC (PIC 2) or into cores of multicore fibers. The couplers 802, 804, 822, 824 are designed using adjoint optimization and a two-level silicon etch process (FIG. 8B). Here, an inversed-designed coupler uses a 2-level silicon etch and a bilayer coupler employing both silicon and Si₃N₄ layers. The use of a silicon nitride layer can further increase the bandwidth and efficiency of the couplers 802, 804, 822, 824. Since metalenses offer high numerical aperture (NA) imaging over large fields of view with high efficiency and can be fabricated at foundries, the imaging approach of FIG. 8A offers high-density low-crosstalk coupling because every grating coupler in a closely-packed array, as demonstrated in FIG. 8C, is imaged to its corresponding coupler or fiber core on another PIC or a multi-core fiber through the same metalens aperture. In various embodiments, the metalens substrate can also function as an electrical interposer for the PICs.

In accordance with embodiments of the present disclosure, high-density, low-loss, wideband coupling arrays enable 3D heterogeneous integration of PICs for applications such as quantum optics, optical AI accelerators, and multimodal sensors, and, when used for coupling to multicore fibers, can significantly increase the data rates for communication.

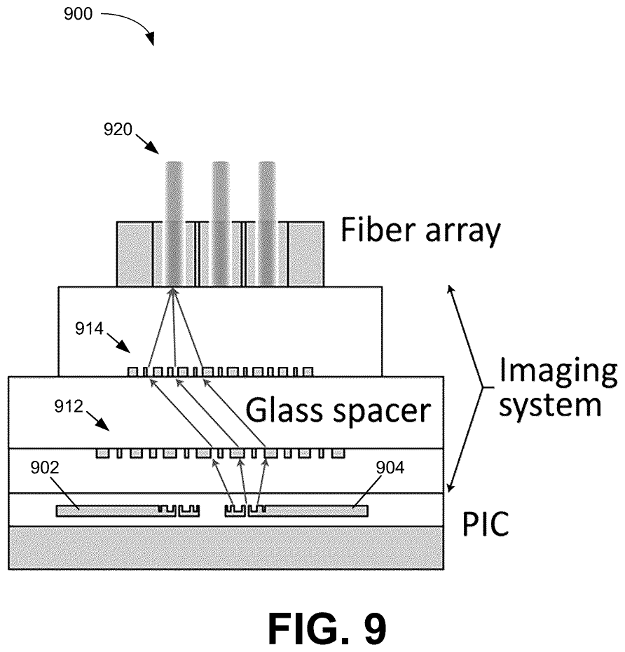

While FIG. 8A shows the coupling between two PICs, FIG. 9 is an exemplary coupler array and imaging system 900 showing the coupling between a PIC and a fiber array, in accordance with various embodiments. An exemplary embodiment employs small-area (a few microns by a few microns) grating couplers 902, 904 that efficiently emit upward and into the acceptance cone of a metalens-based imaging system. In various embodiments, the couplers 902, 904 may have large directionality (the ratio of the power emitted upward to the one emitted downward), and wide bandwidth (>100 nm, 3 dB), while being fabricatable using commercial foundry processes.

Due to their importance, many different designs of grating couplers have been studied and commercial foundries already offer several options in their process design kits (PDK) s. Almost all these grating couplers have been designed for directly coupling into single-mode fibers with a mode field diameter of ˜10 μm at 1550 nm, and, as a result, their emission apertures are larger than 10 μm in diameter. Furthermore, the best-reported fiber coupling efficiencies are ˜85% at the coupler's peak wavelength. Grating couplers with aperture diameters smaller than 10 μm can emit more than 95% of their input powers upward and within the acceptance cone (NA of 0.3 or larger) of the metalens imaging system at the wavelength of 1550 nm.

Referring back to FIG. 8A and FIG. 9, the light emitted by one of the couplers 902, 904 is imaged using an imaging system composed of two cascaded metalenses 912, 914 (metalens doublet apparatus). When coupling between two PICs with similar grating couplers (FIG. 8A), a diffraction-limited imaging system with a magnification of unity can be used. Such an imaging system faithfully relays the field at the output aperture of the emitting grating coupler 804 to the aperture of the receiving grating coupler 824. The one-to-one relay is important in achieving a very low loss because the fields emitted by the grating couplers 802, 804 do not have to have a specific profile (as is the case when coupling into an optical fiber). A high coupling efficiency is achieved as long as the two couplers are similar and emit with planar wavefront into the acceptance cone of the imaging system.

For the coupling between a PIC and a fiber array, as illustrated in FIG. 9, one may consider coupling into multi-core single-mode fibers 920 that are arrayed along one dimension using a V-groove (but the concept applies to 2D fiber arrays as well). For coupling into fiber cores, depending on the fiber's mode field diameter, the imaging system might need to have a magnification larger than unity to image a small grating coupler aperture onto the fiber core. Also, in this case, the mode shape emitted by the grating coupler may be almost Gaussian.

Grating couplers with fiber coupling efficiency as high as 85% have been reported and it has been shown that coupling into fibers with smaller mode field diameters can be even more efficient. Considering these results and the fact that, in the disclosed approach of FIG. 9, the emitted power into the acceptance cone of the imaging system does not need to have a specific mode shape (in contrast to fiber coupling where it has to be Gaussian), a higher coupling efficiency is offered by the disclosed technique. The reason that the mode shape can be used as a degree of freedom is the diffraction-limited imaging with a magnification of unity and the identical mode shapes of the emitting and receiving grating couplers.

In various embodiments, to achieve the highest efficiency and to ensure attaining the widest possible bandwidth of the coupler, all 3D degrees of freedom available in a commercial foundry process can be used. To this end, shape and topology optimization based on an adjoint method (also referred to as inverse design) can be employed in various embodiments. The adjoint technique allows for determining the gradient of an objective function with respect to all design parameters using only two full-wave simulations, enabling the optimization of designs with a very large number of parameters. In addition, the objective function can be properly selected to achieve the best trade-off between performance metrics, and constraints such as the ones imposed by commercial foundries can be imposed during the optimization process.

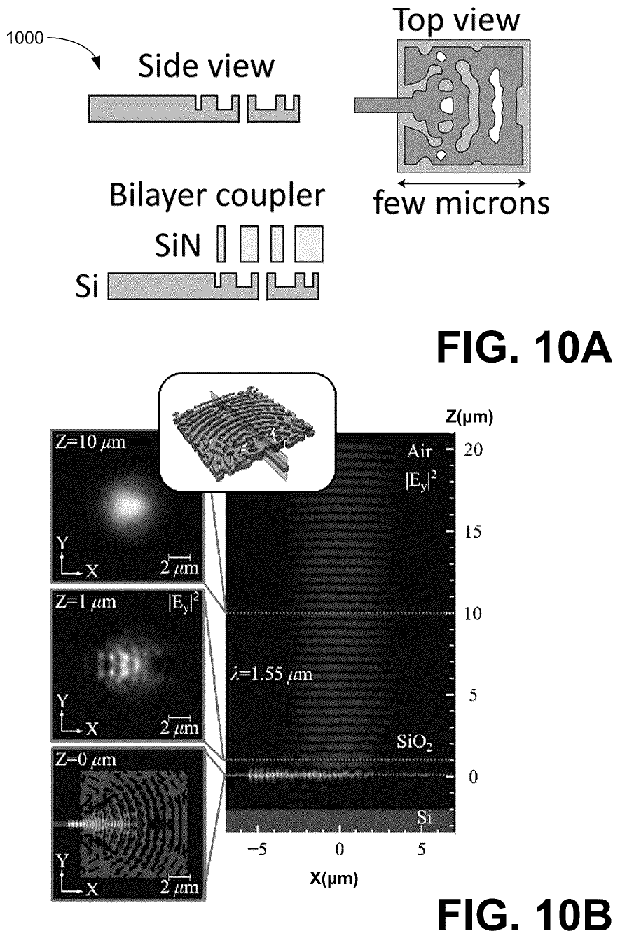

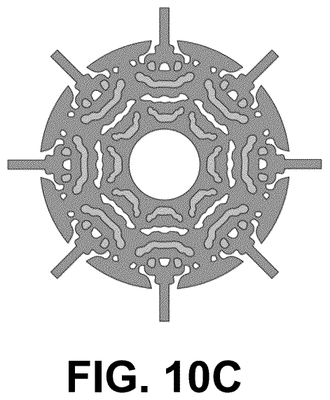

Referring now to FIG. 10A, this figure shows an example shape/topology-optimized grating coupler 1000. The coupler utilizes different patterns for two-level silicon etch depth offered by foundries (some foundry processes offer three depths) to break the symmetry and increase the directionality of the emission. The addition of a patterned silicon nitride layer that is offered by most foundries can further increase the directionality, and the added degrees of freedom may increase the efficiency and bandwidth of the coupler.

The shape/topology adjoint optimization can be implemented using the finite-different time-domain (FDTD) simulations. Compared to implementations that utilize frequency domain solvers, FDTD-based implementation is significantly faster because it does not require multiple simulations at different wavelengths, and the gradient vectors at all wavelengths are computed using two time-domain simulations. The FDTD implementation enables optimization of large structures (e.g., a metalens with an aperture of 60λ₀×60×λ₀). More recently, using a similar FDTD implementation and by including the constraints enforced by a foundry process (e.g., minimum linewidth, linespacing, area, enclosed area, and curvature), a bilayer coupler (poly-silicon on SOI) can be designed and fabricated using the GlobalFoundries process. FIG. 10B shows the simulation results of an optimized design, which indicates almost all the input power is emitted by the coupler upward over a narrow range of angles. The coupler has a peak fiber coupling efficacy of −1.2 dB and a 3 dB bandwidth of 73 nm. Considering that the efficiency metric for an exemplary approach is less stringent (percentage of the power emitted into a 0.3 NA cone versus the overlap with a 0.14 NA fiber mode), this example affirms the feasibility of a coupler, especially when adding the degrees of freedom offered by the SiN layer.

Two potential array configurations of the couplers are shown in FIG. 8C and FIG. 10C. A higher density arrangement might be achievable by using the configuration in FIG. 10C, which by itself can be arrayed in 2D. Note that the coupler's arrangement on the emitting and receiving PICs must mirror each other given the unity-magnification imaging system.

For coupling light between couplers on two different PICs, an exemplary approach uses an imaging system with unity magnification instead of directly coupling them. Compared to direct coupling, the imaging approach allows for smaller couplers (i.e., higher density and smaller footprint), larger coupling efficiency, and a wider bandwidth.

In various embodiments, to directly couple light between grating couplers on different PICs, the aperture size of the couplers can be large enough to prevent divergence of its beam or allow for focusing of the beam over the distance between the PICs. In various embodiments, a typical distance between PICs should be at least a few hundred microns to allow for electrical connections or the insertion of an electrical interposer, which means that a large coupler aperture size (˜100 μm or larger) would be required for direct coupling. The emission profiles of the two couplers may also be optimized to ensure field profile of the light emitted from a coupler and diffracted in the distance between them matches the field at the aperture of the receiving coupler. Such a matching requirement reduces the coupling efficiency. More importantly, grating couplers with large apertures have directional emissions that steer with wavelength and lead to their narrow bandwidth.

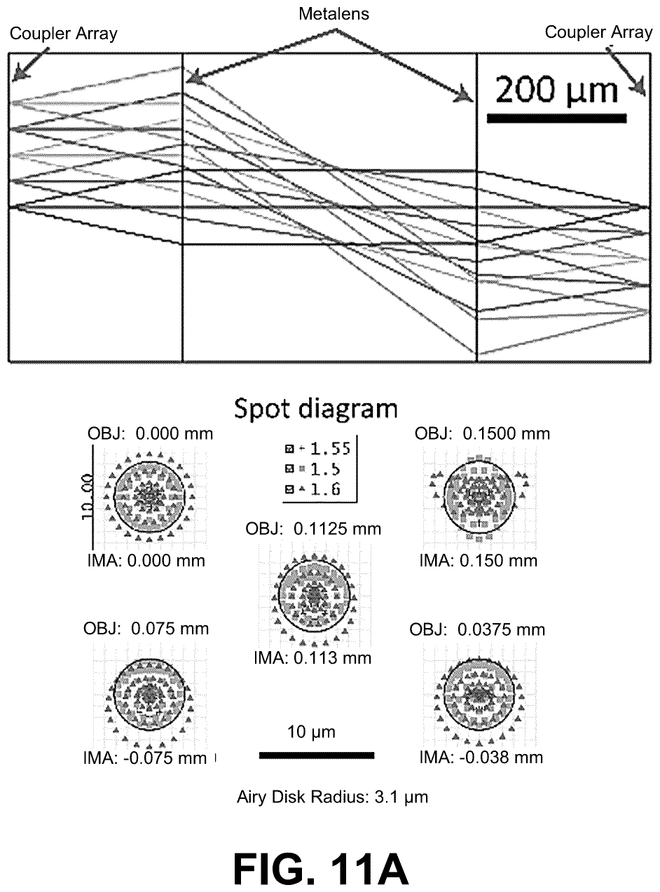

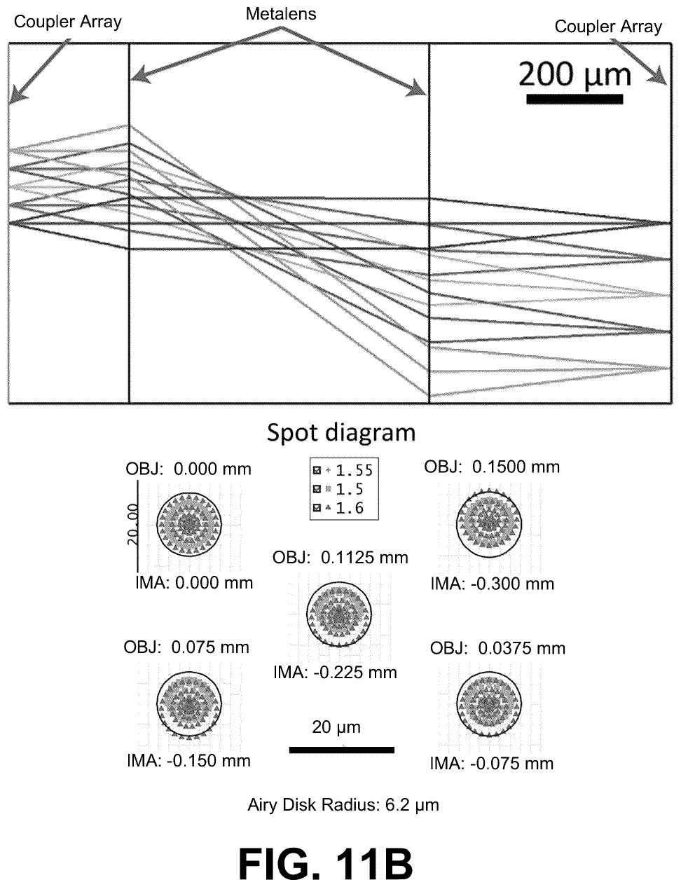

FIG. 11A shows ray tracing simulation results for a diffraction-limited imaging system with unity magnification composed of two cascaded similar metalenses with a diameter of 400 μm. As the simulated spot diagram in FIG. 11B shows, the imaging system is diffraction limited over a 100 nm bandwidth (i.e., its spot size is determined by the Airy disk, which is shown by a circle on the spot diagram, rather than aberrations). The imaging system shown in FIG. 11A has a numerical aperture (NA) of 0.3, a field of view (FoV) of 300 μm (diameter), and is telecentric in both object and image spaces (i.e., chief rays are normal to the object and image planes). The telecentricity of the system enables uniform imaging across the field of view independent of the location of the emitter inside the FoV, allowing for using similar grating couplers across the array. It is noted that a single metalens imaging system with a similar NA does not offer any of these features (i.e., large diffraction-limited FoV and bandwidth and telecentricity), and therefore the metalens doublet is the simplest possible solution.

Here, the NA of the imaging system is selected as 0.3 to increase the collection ability of the imaging system (compared to fiber coupling) and thus the efficiency of the couplers while keeping the alignment tolerance between the PICS and metalenses larger than 1 μm. For this NA, the Airy disk diameter of 6.2 μm enables 1 dB misalignment tolerance of larger than 1 μm. The 300-μm-diameter FoV of the imaging system allows for simultaneous imaging of more than 100 couplers arranged in arrays shown in FIGS. 8C and 10C.

FIG. 11B shows another metalens doublet imaging system that has the same characteristics as the one shown in FIG. 11A, except for having a magnification of two and thus an image space NA of 0.15. This type of system can be used for coupling between a PIC and a multi-core fiber array. The magnification of two enables a four times denser coupler array compared to fiber cores.

The physical dimensions of designs shown in FIGS. 11A-11B can all be scaled down by the same factor to reduce aberrations and allow for a diffraction-limited system with a wider bandwidth and/or a higher NA. The smaller FoV can be compensated for by using an array of side-by-side fabricated imaging systems if needed.

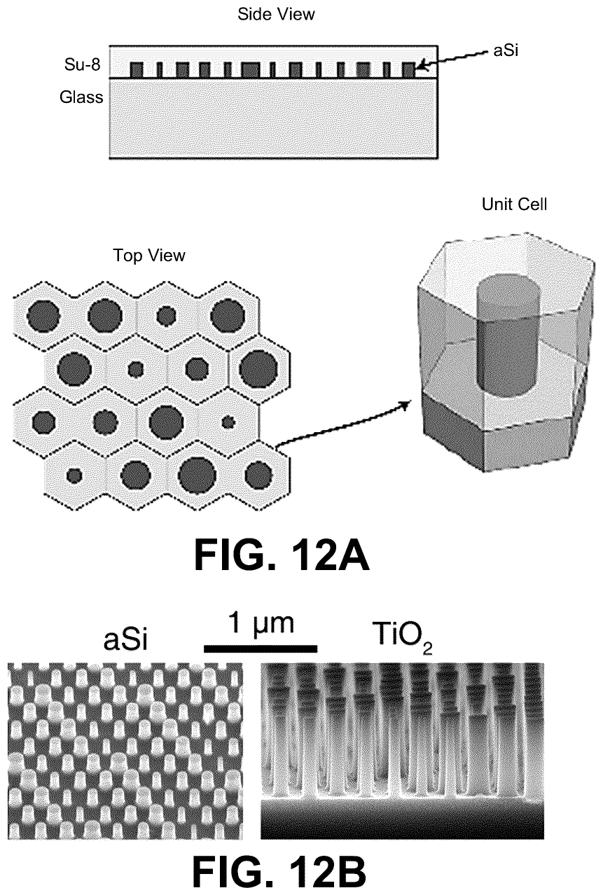

In various embodiments, metalenses can be realized using the amorphous silicon (aSi) nano-post platform that is shown in FIG. 12A. Metalenses with focusing efficiencies reaching 97% have been demonstrated which makes it possible to achieve a 94% efficiency for the metalens doublets. Accordingly, FIG. 12B shows SEM images of aSi and TiO₂ nano-posts in accordance with various embodiments of the present disclosure. Foundry-type fabrication of nano-post metalenses on 200 mm or 300 mm wafers is offered by several commercial vendors including UNITED MICROELECTRONICS CORPORATION (UMC), NIL TECHNOLOGY, MOXTEK, and MYRIAS OPTICS. For example, NIL TECHNOLOGY has announced a focusing efficiency of 94% for their aSi metalenses.

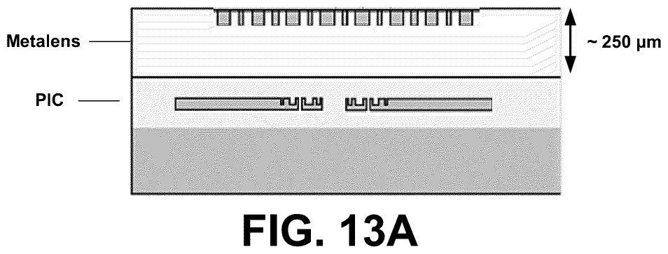

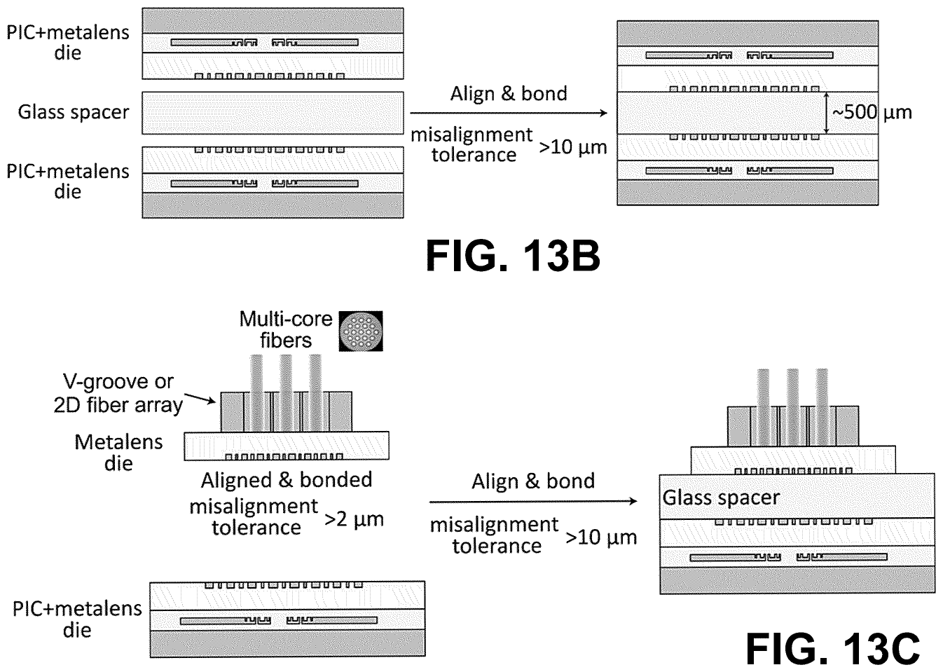

FIGS. 13A-13C show an exemplary plan for the alignment and bonding steps needed for implementing the disclosed coupling approach, in accordance with various embodiments. Metalens and PIC dies can be aligned and bonded together, as shown in FIG. 13A. The misalignment tolerance of this step is set by the Airy disk of the metalens (6 μm diameter) and is larger than 1 μm. As such, the inventors have previously developed simple holographic alignment marks that enable 3D alignment of two samples with sub-50 nm precision. In various embodiments, the metalens die can be smaller than the PICs to allow for electrical connections to the die or the metalens substrate can also serve as an electrical interposer. In the latter case, the metalens and PIC wafers can be bonded and then diced. Also, the thickness of the metalens wafer (or die) can be reduced after fabrication by lapping and polishing process to allow for filling the gaps between the dies using a UV curable adhesive

Next, in FIG. 13B, two metalens-bonded PICs are aligned with a spacer layer inserted in between and bonded together. In various embodiments, the 1 dB misalignment tolerance for this step is larger than 10 μm because the light is collimated and has a diameter of ˜100 μm between the two metalenses (see FIG. 11A). As FIG. 13C shows, a similar process can be used for coupling between PICs and fiber arrays.

Various embodiments of the present disclosure are directed to a low-loss and wideband imaging-based system for coupling light from an array of waveguides on a photonic integrated circuit (PIC) to a second array of waveguides on another PIC or to multi-core optical fibers. Such an approach is compatible with foundry-fabricated PICS and enables optical/electrical 3D integration as well as high data rates via multicore fibers for applications in communications, on-chip interconnects, optical artificial intelligence (AI) accelerators, and multimodal sensors.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

1. A system comprising:
a metalens doublet structure having a first substrate; a first metalens structure provided at a surface of the first substrate and comprising a plurality of first scatterers; and a second metalens structure provided at a second substrate or on another surface of the first substrate and comprising a plurality of second scatterers,
wherein the plurality of first scatterers is configured to reshape an intensity distribution of light that is received by the first metalens structure at a location of the second metalens structure; and
wherein the plurality of second scatterers is configured to change a wavefront of the light outputted from the first metalens structure and incident on the second metalens structure.

2. The system of claim 1, wherein each of the plurality of first scatterers and the plurality of second scatterers has at least one of a cylindrical shape, a cylindroid shape, or a polyhedral pillar shape.

3. The system of claim 1, further comprising a laser diode device that is configured to output a laser beam that is received by the first metalens structure.

4. The system of claim 3, further comprising an optical filter positioned between the laser diode device and the first metalens structure, wherein the optical filter is configured to transmit light having a wavelength equal or similar to a design wavelength of the first metalens structure.

5. The system of claim 1, wherein a phase profile of the first metalens structure is designed to reshape an elliptical-shaped intensity distribution of a laser beam to a circular shape intensity distribution at the location of the second metalens structure.

6. The system of claim 5, wherein a phase profile of the second metalens structure is designed to collimate the light outputted from the first metalens structure.

7. The system of claim 1, wherein a phase profile of the first metalens structure is designed to reshape an elliptical-shaped intensity distribution of a laser beam to a different elliptical-shaped intensity distribution at the location of the second metalens structure.

8. The system of claim 7, wherein a phase profile of the second metalens structure is designed to collimate the laser beam outputted from the first metalens structure.

9. The system of claim 1, wherein a phase profile of the first metalens structure is designed to reshape the intensity distribution of the light as the light passes through the plurality of first scatterers such that the reshaped intensity distribution matches a desired intensity distribution at a location of the second metalens structure.

10. The system of claim 7, wherein a phase profile of the second metalens structure is designed to focus a wavefront of incident light onto an end of a waveguide structure.

11. The system of claim 9, wherein a phase profile of the second metalens structure is designed to focus a wavefront of incident light onto an end of a waveguide structure.

12. The system of claim 1, wherein the first and second scatterers comprise amorphous silicon.

13. The system of claim 1, wherein the first substrate or the second substrate comprise a glass substrate.

14. The system of claim 1, wherein the first substrate and the second substrate are bonded together.

15. The system of claim 1, wherein the first metalens structure is substantially parallel with respect to the second metalens structure.

16. The system of claim 1, wherein the first metalens structure is oblique with respect to the second metalens structure.

17. A method comprising:
forming a first metalens structure on a surface of a first piece of substrate, wherein the first metalens structure comprises a plurality of first scatterers that are configured to reshape an intensity distribution a beam of light that is received by the first metalens structure;
forming a second metalens structure on a surface of a second piece of substrate, wherein the second metalens structure comprises a plurality of second scatterers that are configured to change a wavefront of an incident light beam; and
bonding one surface of the first piece of substrate and one surface of the second piece of substrate together to form a metalens doublet structure.

18. The method of claim 17, further comprising using the metalens doublet structure to couple light from a first photonic integrated circuit to a second photonic integrated circuit.

19. The method of claim 18, wherein the light is coupled between a grating coupler on the first photonic integrated circuit and a grating coupler on the second photonic integrated circuit.

20. The method of claim 17, further comprising using the metalens doublet structure to couple light from an array of waveguides on a first photonic integrated circuit to multi-core optical fibers.
